(19) United States
(12) Patent Application Publication
(10) Pub. No.: US 2016/0375947 A1
(43) Pub. Date: Dec. 29, 2016

(54) Luggage Rack System for a Motorized Two-Wheeler

(71) Applicant: Bayerische Motoren Werke Aktiengesellschaft, Muenchen (DE)

(72) Inventor: Raimund BRANDL, Aschheim (DE)

(21) Appl. No.: 15/264,004

(22) Filed: Sep. 13, 2016

Related U.S. Application Data
(63) Continuation of application No. PCT/EP2015/051131, filed on Jan. 21, 2015.

(30) Foreign Application Priority Data
Mar. 14, 2014 (DE) 10 2014 204 740.4

(51) Int. Cl. B62J 7/04

(52) U.S. Cl. CPC B62J 7/04

(57) ABSTRACT

A luggage rack system for a motorized two-wheeler includes a support and a top case. The top case is mounted to the support such that it can be swiveled from a travel position about a swivel axis lying transversely to the longitudinal direction of the two-wheeler into a second position in order to make it easier for the rider or passenger to mount or dismount the two-wheeler.

### CROSS REFERENCE TO RELATED APPLICATIONS

This application is a continuation of PCT International Application No. PCT/EP2015/051.131, filed Jan. 21, 2015, which claims priority under 35 U.S.C. §119 from German Patent Application No. 10 2014 204 740.4, filed Mar. 14, 2014, the entire disclosures of which are herein expressly incorporated by reference.

### BACKGROUND AND SUMMARY OF THE INVENTION

The invention relates to a luggage rack system for a motorized two-wheeler, particularly a motorcycle or a motor scooter.

For transporting luggage on a motorcycle or motor scooter, the use of so-called top cases, thus, luggage suitcases, is widespread. These top cases are fastened on a support at the rearward end of the two-wheeler in such a fashion that they are arranged on the top of the support and, in the top view, are situated in the center over a longitudinal axis of the two wheeler.

It is known, for example, from German Patent document DE 38 24 610 A1 to mount a top case on the support such that it can be displaced along the longitudinal direction of the vehicle in order to be able to influence the position of the center of gravity of the vehicle. However, even in this case, there is the problem that the top case will be in the way when the motorcyclist, and especially the passenger, mount and dismount the two-wheeler.

It is an object of the invention to provide a luggage rack system that makes the mounting or dismounting more comfortable in the case of a motorized two-wheeler.

According to the invention, it is provided that, in the case of a luggage rack system for a motorized two-wheeler having a support and a top case, the top case is fastened to the support such that it can be swiveled from a travel position about a swivel axis situated transversely to the longitudinal direction of the two-wheeler into a second position, in order to facilitate a mounting or dismounting by the motorcyclist and/or passenger. Before the mounting and dismounting respectively, the top case is swiveled from the travel position into its second position, whereby it tilts rearward about the swivel axis. After the mounting and dismounting respectively, the top case will be swiveled back into the travel position. In this mariner, the clearance behind the seat bench is enlarged for the mounting and dismounting, so that a more comfortable swinging of the right leg over the seat bench becomes possible.

The support may, for example, be a luggage rack of the two-wheeler or a suitable adapter fastened to the luggage rack.

The top case is preferably arranged to be swivelable by approximately 90. In this case, a bottom side of the top case in the second position extends in an approximately vertical line. It was found that a sufficient freedom of motion for the motorcyclist and the passenger is achieved in this manner.

In order to be able to swivel the top case beyond the rearward end of the support, it is advantageous for the swivel axis to be arranged at the rearward end of the support.

Likewise, it is advantageous for the swivel axis to be disposed on a bottom side of the top case and to be arranged offset with respect to a rearward end of the top case, because in this manner the height of the protrusion of the top case over the support in the second position can be reduced, which further reduces the danger that the leg may get caught.

The swivel axis is advantageously defined by one or more bearings or hinges.

In one embodiment, the swiveling of the top case takes place manually from the travel position into the second position.

Preferably, an energy storage device is provided, which is charged when the top case is swiveled into the second position and which at least supports the restoring of the top case into the travel position. In this manner, the swiveling-back of the top case is simplified if this takes place manually. It is advantageous to provide a release device for releasing the energy storage device in order to be able to keep the energy storage device locked until the top case is swiveled back.

The energy storage device may, for example, be a spring, such as a spiral spring or a gas spring, and the release device preferably is a locking device that is locked when the top case reaches the second position and which is released when the release device is operated. This results in an easy charging of the energy storage device during the swiveling of the top case into the second position as well as an easy supporting of the restoring into the travel position.

Particularly when the swiveling of the top case takes place manually, it is advantageous to provide a safety device so that the two-wheeler cannot be driven away when the top case is in the second position. The safety device preferably includes an electric switch which is operated during the swiveling of the top case. The switch may be closed in the second position or in the travel position, and may be open in the respective other position. A suitable electronic system detects the switch position and correspondingly triggers the safety device when the top case is swiveled into the second position.

The safety device preferably includes a warning light and/or a starting or immobilizer lock. A warning light in the cockpit points out to the motorcyclist, for example, that the top case is not in the correct travel position. As an alternative or in addition, possibly the starting of the motor of the two-wheeler may be prevented or the motor may be stopped during the starting attempt.

In another preferred embodiment, an electric-motor driven operating device may be provided, which swivels the top case from the travel position into the second position and/or from the second into the travel position.

The electric-motor driven operating device may be operated, for example, by a switch in the cockpit and/or a switch at the support. In the latter case, it is also easy for the passenger to initiate the swiveling of the top case, because the switch is easily reachable.

It is also contemplated to connect an electric-motor driven operation with a mechanical energy storage device and, for example, by way of the electric motor, swivel the top case from the travel position into the second position and use the energy storage device at least in a supporting manner for the restoring movement.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic partial view of a motorized two-wheeler with a luggage rack system according to an embodiment of the invention, in which the top case is in a travel position; and

FIG. 2 is a view of the motorized two-wheeler having the luggage rack system from FIG. 1, wherein the top case is swiveled into the second position.

### DETAILED DESCRIPTION OF THE DRAWINGS

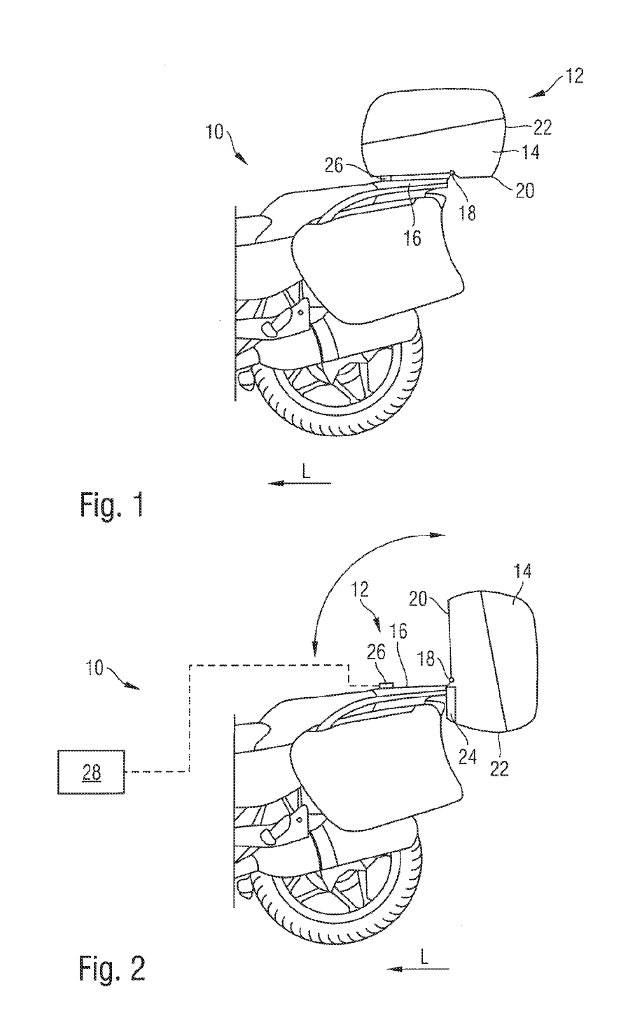

FIGS. 1 and 2 show a motorized two-wheeler 10, here a motorcycle or a motor scooter, of which only the rearward part is illustrated.

The two-wheeler 10 is equipped with a luggage rack system 12 that includes a top case 14 fastened to a support 16. Here, the support 16 is formed by a luggage rack of the two-wheeler 10.

FIG. 1 illustrates the top case 14 in its travel position, in which it is arranged on top of the support 16 and, in the top view, is situated in the center over a longitudinal axis L of the two-wheeler 10.

The top case 14 can be swiveled from the travel position shown in FIG. 1 into the second position shown in FIG. 2, and back.

For this purpose, the top case 14 is swivelably connected with the support 16 by way of a bearing, which is not shown in detail and defines a swivel axis 18, so that it can be tilted rearward along the longitudinal axis L of the two-wheeler 10. In this example, the swivel axis 18 is situated at a rearward end of the support 16 and at the bottom side 20 of the top case 14 and is positioned to be offset some distance with respect to the rearward end 22 of the top case 14. As a result, during a swiveling of the top case 14, the rearward end 22 swings downward (see FIG. 2). The bottom side 20 will then extend approximately in a vertical line.

In the travel position, the top case 14 is locked to the support 16 by a mechanism (not shown), so that it cannot swivel by itself into the second position. This locking has to be released for the swiveling.

In a first embodiment, the swiveling of the top case 14 takes place manually in that the motorcyclist or passenger releases the locking and moves the top case 14 into the second position. After the mounting or dismounting, the top case 14 is manually swiveled back into the travel position.

An energy storage device 24 (shown schematically in FIG. 2), such as a screw spring or a gas spring, may be provided, which stores a portion of the energy, which is generated during the swiveling into the second position, in the form of an initial tension, in order to assist, by means of the stored energy, the swiveling of the top case from the second position back into the travel position. The stored energy will be released when a release device (not shown) is operated.

In a second embodiment, an electric-motor driven operating device is provided (not shown), which causes the swiveling of the top case by way of a corresponding drive by way of an electric motor.

The electric-motor driven operating device can be operated, for example, by a switch in the cockpit or a switch at the support 16.

A sensor, such as an electric switch 26, is provided in the embodiment illustrated here, which switch 26 makes it possible to detect when the top case 14 is not in the travel position. In this case, the switch 26 is designed such that it is closed in the travel position.

The switch 26 is connected with a safety device 28 (shown schematically in FIG. 2), which here corresponds to a warning light in the cockpit when the top case 14 is in the second position. In addition, in this example, the safety device 28 has the effect that a vehicle immobilizer lock is switched on, so that the two-wheeler 10 cannot be moved when the top case 14 is in the second position.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A luggage rack system for a motorized two-wheeler, comprising:
a support;
a top case fastened to the support, wherein
the top case is swivelable from a travel position about a swivel axis situated transversely to a longitudinal direction of the two-wheeler into a second position, whereby mounting or dismounting of the two-wheeler by a user is facilitated.

2. The luggage rack system according to claim 1, wherein the top case is swivelable by approximately 90°.

3. The luggage rack system according to claim 2, wherein the swivel axis is arranged at a rearward end of the support of the two-wheeler.

4. The luggage rack system according to claim 1, wherein the swivel axis is arranged at a rearward end of the support of the two-wheeler.

5. The luggage rack system according to claim 3, wherein the swivel axis is arranged at a bottom side of the top case and is located offset in a forward longitudinal direction with respect to the rearward end of the top case.

6. The luggage rack system according to claim 1, wherein the swivel axis is arranged at a bottom side of the top case and is located offset in a forward longitudinal direction with respect to a rearward end of the top case.

7. The luggage rack system according to claim 1, further comprising:
an energy storage device configured to be charged when the top case is swiveled into the second position;
a release device configured to release the energy storage device, wherein
the energy storage device assists a restoring of the top case into the travel position.

8. The luggage rack system according to claim 7, wherein
the energy storage device is a spring, and
the release device comprises a locking device which is locked when the top case reaches the second position and is unlocked when the release device is operated.

9. The luggage rack system according to claim 1, further comprising:
a safety device configured to prevent a driving away of the two-wheeler when a top case is in the second position, wherein
the safety device comprises an electric switch operated during the swiveling of the top case.

10. The luggage rack system according to claim 9, wherein the safety device further comprises one or more of a warning light, a starting lock or an immobilizer lock.

11. The luggage rack system according to claim 1, further comprising:
an electric-motor driven operating device configured to adjust the top case from the travel position into the second position or from the second position into the travel position.

12. The luggage rack system according to claim 11, wherein the electric-motor driven operating device is operable via a switch in a cockpit of the two-wheeler or at the support of the two-wheeler.
